(19) United States
(12) Patent Application Publication
(10) Pub. No.: US 2021/0061384 A1
(43) Pub. Date: Mar. 4, 2021

(54) Swivel Joint Type Bicycle Stand

(71) Applicant: Hyon Kyoung Rah, Washington, DC (US)

(72) Inventor: Hyon Kyoung Rah, Washington, DC (US)

(21) Appl. No.: 16/933,473

(22) Filed: Jul. 20, 2020

(30) Foreign Application Priority Data
Aug. 28, 2019 (KR) 10-2019-0105722

(51) Int. Cl. B62H 3/06

(52) U.S. Cl. CPC B62H 3/06

(57) ABSTRACT

The present invention relates to a swivel join type bicycle stand, consisting of: a main bar 100 installed in a horizontal orientation, a sliding bracket 200 slidably coupled on one side with the main bar 100, and a mounting rack 300 which is rotatably coupled with the other side of the sliding bracket 200, wherein the mounting rack 300 can fold outward to accommodate bicycle parking and storage; the mounting rack 300 can be rotated inward and folded when a bicycle stand is not needed.

### TECHNICAL FIELD

The present invention relates generally to bicycle stands and more specifically to a foldable bicycle stand with swivel joints, which can facilitate efficient use of space through folding and nesting of mounting frames that can be expanded to form a full stand when needed.

### DESCRIPTION OF THE PRIOR ART

In recent years, increasing numbers of people have been riding bicycles to bus stops and subway stations close to their homes, storing their bicycles at transit stops to transfer to buses and subways. Installations of bicycle stands are also increasing in multi-family residential complexes and public spaces. The bicycle stand shown in FIG. 1 is a typical example.

The bicycle stand (1) shown in FIG. 1 consists of a main frame (2) to fix the bicycle stand to the ground while keeping each individual mounting frame (3) spaced apart at a predetermined distance. The mounting frame (3) allows the front wheel of a bicycle to be mounted and secured.

This conventional bicycle stand (1) stands above ground at all times and occupies space even when there are no bicycles that need to be stored. In cases where space efficiency is a priority, this poses a problem.

In order to address this problem, an embeddable bicycle stand was developed, as shown in FIG. 2. The embeddable bicycle stand consists of: a main bracket (10) that is buried in the ground on which bicycles can be parked; a pivoting bracket (20) which is nested inside the main bracket (10) and can be lifted to form a stand to support the front wheel of the bicycle; a rotating spring (30) to apply elastic force for the pivoting bracket (20) to rise from the embedded position to the standing position to support the front wheel of the bicycle in need of a stand; a triggering pedal (40), located inside the main bracket (10), which triggers the pivoting bracket (20) to stand when pressed with the front wheel of a bicycle. While the collapsible nature of the pivoting bracket (20) offers flexibility in the use of space, this device presents potential safety and maintenance concerns. Any external pressure comparable to that of a wheel of a bicycle, including a foot of a pedestrian, can activate the trigger pedal (40) and cause the pivoting bracket (20) to spring up with elastic force, posing a safety risk. Because the space inside the main bracket (10) where the pivoting bracket (20) and triggering pedal (40) rest is hollow and exposed to the elements, there is a high probability that foreign matter is introduced into this area, jamming the area around the triggering pedal (40) or otherwise causing the elastic spring mechanism to malfunction. Accumulation of foreign matters inside the main bracket (10) could make it difficult for the pivoting bracket (20) to return to its nesting position inside the main bracket (10) when the bicycle stand is not in use.
Patent Document 1: Korean Patent Publication No. 10-2011-0008454 (KR10-2011-0008454 A.)
Patent Document 2: Registered Korean Patent No. 10-1660263 (10-1660263 B.)

### BRIEF SUMMARY OF THE INVENTION

### Problem to Solve

An object of the present invention is to provide a bicycle stand that can efficiently utilize space without posing safety risks.

### Solution to the Problem

The present invention relates to a bicycle stand for parking and securing bicycles indoors and outdoors. It consists of the following: a main bar 100 installed in the horizontal orientation; a slidable bracket 200 slidably coupled with the main bar 100; a mounting rack 300 rotatably coupled with the slidable bracket 200. The mounting rack 300 rests perpendicular to the slidable bracket 200 in a folded position when not in use for bicycle parking and can be folded out when bicycles need to be parked and secured. Multiple slidable brackets 200 can be arranged along the main bar 100, overlapping with successively increasing horizontal length, with mounting racks 300 attached to each that are folded, nested, and gathered together.

### Effects of the Invention

The technical effects of the present invention are as follows:

The sliding bracket 200 can slide along the main bar 100, and the mounting rack 300, rotatably coupled with the sliding bracket 200, can fold outward to accommodate a bicycle when a bicycle stand is needed. Rather than occupying space when the bicycle stand is not in use, multiple mounting racks 300 can be folded into each other in a nested form and leave the space that otherwise would have been occupied free for other uses.

Potential accidents and safety risks are minimized as the current invention does not require a spring or elastic motion for deployment.

The main operating components are above ground to mitigate the risk of malfunction due to infiltration or accumulation of foreign matter, such as dirt.

### BRIEF DESCRIPTION OF DRAWINGS

Various other objects, features and attendant advantages of the present invention will become fully appreciated when considered in conjunction with the accompanying drawings, in which like reference characters designate the same or similar parts throughout the several views:

FIG. 1 (FIG. 1) and FIG. 2 (FIG. 2) show the conventional bicycle stands.

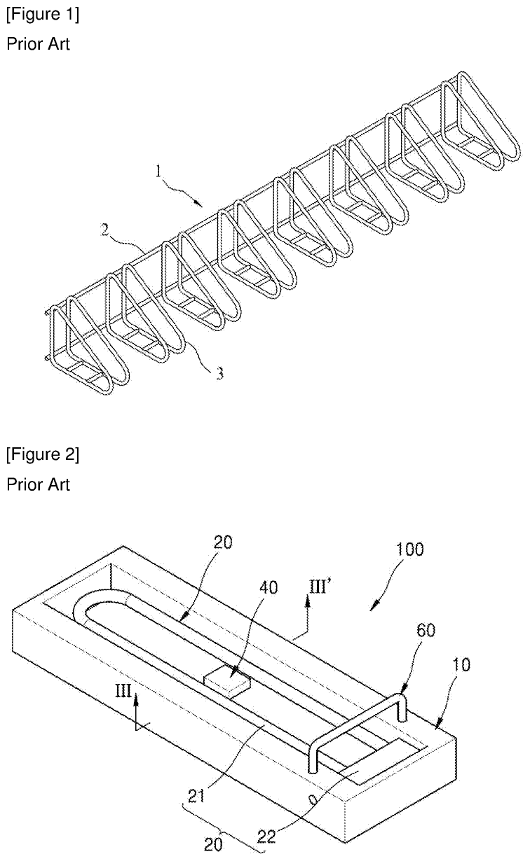

FIG. 3 (FIG. 3) shows a specific embodiment of the present invention: (a) how the main bar 100, sliding bracket 200, and mounting rack 300 connect to each other, (b) plan views from above of multiple sliding brackets 200 and mounting racks 300 across the main bar 100, in folded configuration while not in use and unfolded configuration while in use for bicycle parking.

FIG. 4 (FIG. 4) is a top view illustrating the various configurations of sliding brackets 200 and mounting racks 300 along the main bar 100, including in a nested and condensed arrangement.

FIG. 5 (FIG. 5) shows another specific embodiment of the present invention.

FIG. 6 (FIG. 6) shows another specific embodiment of the present invention.

FIG. 7 (FIG. 7) shows another specific embodiment of the mounting hook 310 for the mounting rack 300.

FIG. 8 (FIG. 8) shows another specific embodiment of the mounting rack 300.

### DETAILED DESCRIPTION OF THE INVENTION

Hereinafter, specific embodiments of the present invention will be described in more detail with reference to the accompanying drawings.

The present invention relates to a bicycle stand consisting of a main bar 100, a sliding bracket 200, and a mounting rack 300.

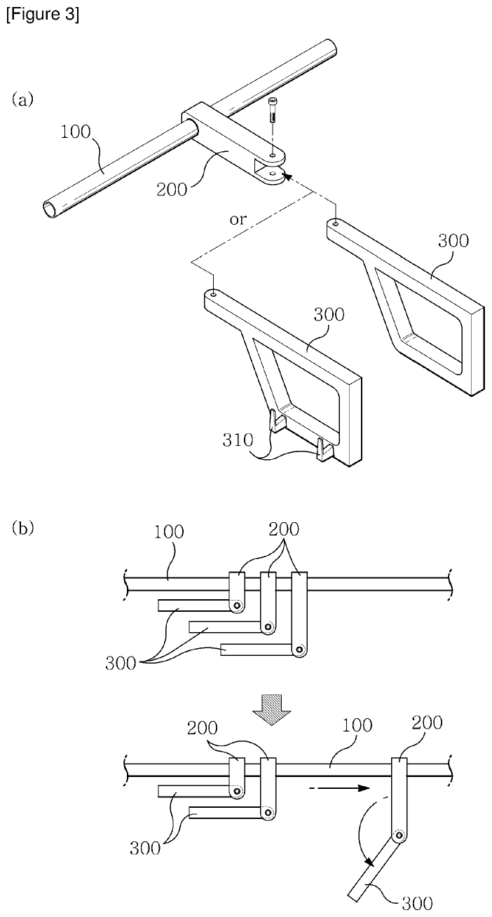

As shown in FIG. 3 (a), the main bar 100 is a structure installed horizontally and can be made of various cross sections of tubes, shaped steel, etc.

Although not illustrated, the ends of the main bar 100 may be installed to maintain a certain height above ground required for bicycle parking, supported by a vertical member perpendicular to the main bar 100, such as a pillar or a column.

As illustrated in FIG. 3 (a), one side of the sliding bracket 200 is slidably coupled with the main bar 100, while the mounting rack 300 is rotatably coupled with the sliding bracket 200. The sliding bracket 200 can slide along the main bar 100 with or without the mounting rack 300 rotated. The specific form and shape of the components are not limited to what is illustrated in the accompanying drawings; design change is possible with various applications.

Mounting rack 300 is rotatably coupled with sliding bracket 200, as shown in FIG. 3 (a). The mounting rack 300 can be rotated outward and unfolded to accommodate for bicycle parking and be rotated inward to be in a folded position when not in use.

The lower part of the mounting rack 300 can include a mounting hook 310 for securing the front or the back wheel of the bicycle, etc., as illustrated in FIG. 3 (a), though there could be configurations that do not contain the mounting hook 310. The specific shape and location of the mounting hook 310 is not limited to the depiction illustrated in the accompanying drawings and the design can be changed in various forms depending on the objects the mounting hook accommodates or secures.

As illustrated in FIG. 3(b), multiple sliding brackets 200 can be arranged in a row along the main bar 100. The sliding brackets 200 sequentially increase in length in the direction perpendicular to the main bar 100 to allow the mounting racks 300 attached to each sliding bracket 200 to be able to overlap and nest into the subsequent pair of mounting rack 300 and sliding bracket 200, minimizing the space occupied when not in use for bicycle storage.

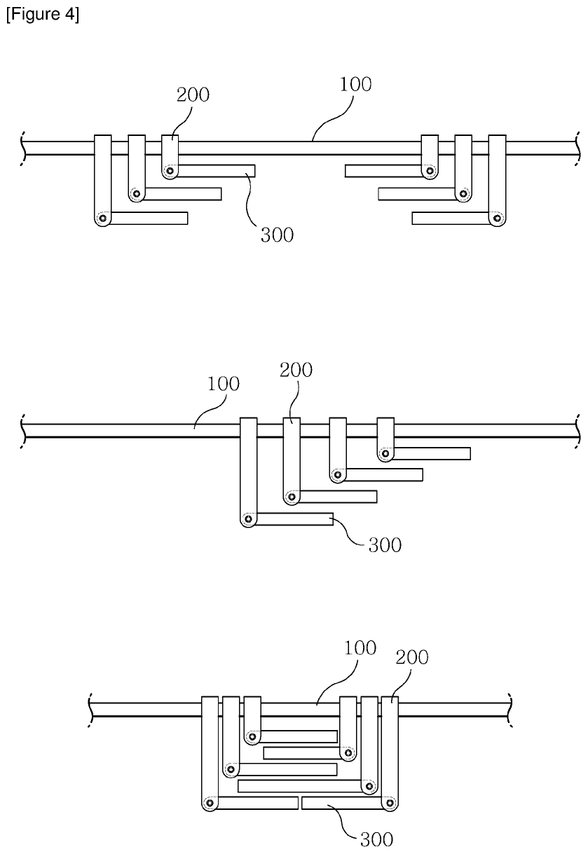

FIG. 4 is a plan view from the top which shows a specific embodiment where a plurality of sliding brackets 200 and the mounting rack 300 are arranged. When not in use for bicycle parking, a plurality of sliding brackets 200 and the mounting rack 300 can be pushed, pulled, and folded inward to assume various nesting and stacking configurations, symmetrically and asymmetrically. The drawing depicts some potential arrangements that are possible but is not inclusive of all possibilities. The specific quantity and configuration would vary depending on the availability of space for the main bar 100, field conditions, and other relevant factors.

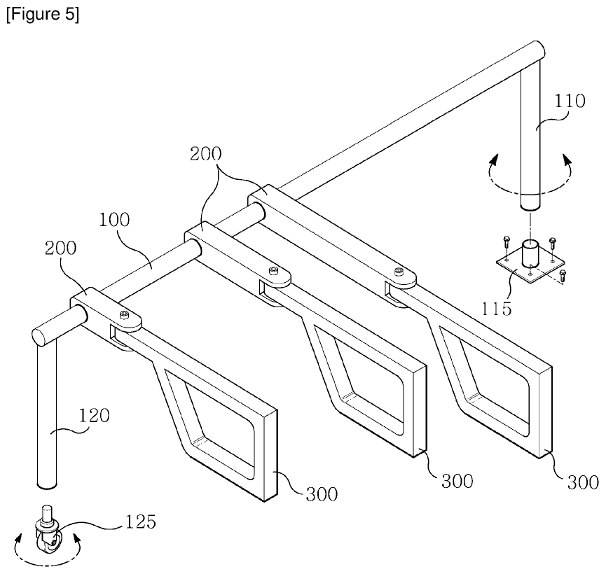

FIG. 5 is another specific embodiment of the present invention and shows a case where the main bar 100 can be rotated in the horizontal direction.

The function of the vertical support element 110 is to support the main bar 100 to stay elevated from the ground at a predetermined distance.

The base bracket 115 is connected to the lower end of the first vertical support member 110.

With the base bracket 115 fixed to the ground, the main bar 100 can be rotated in the horizontal direction as needed, allowing for more flexible use of space.

The second vertical support member 120 can be added to the other end of the main bar 100. The bottom of the second vertical support member 120 is rotatably coupled with a swivel caster 125 so that the main bar 100 can rotate horizontally along the first vertical support section 110 as the main axis. The swivel caster 125 enables the second vertical support member 120 to easily skate on the ground while sharing with the first vertical support member 110 the load of the main bar 100, sliding brackets 200, and mounting brackets 300.

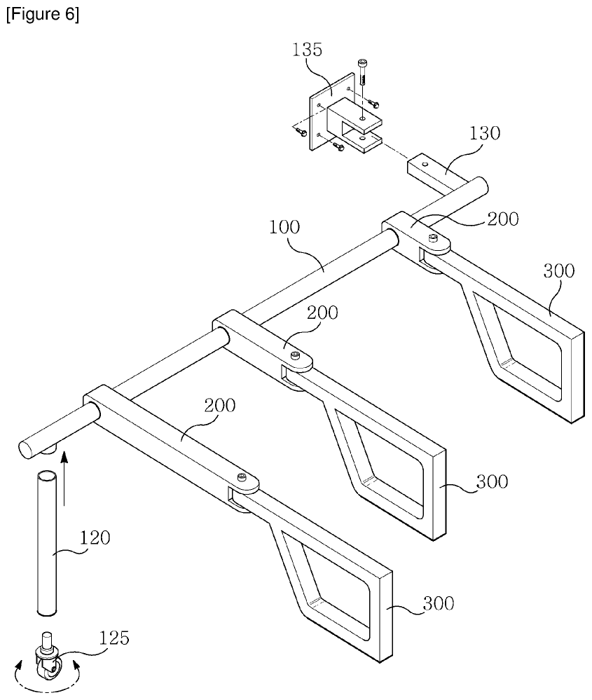

FIG. 6 is another specific embodiment of the current invention, depicting the case where the main bar 100 is installed on a wall using a horizontal support member 130.

The horizontal support member 130 fastens one or both ends of the main bar 100 to a wall fixing bracket 135 which is secured on the wall.

The wall fixing bracket 135, coupled with the horizontal support member 130, is fixed in close contact with the wall and ensures the main bar 100 is spaced apart from the wall and the ground by a predetermined distance.

The horizontal support member 130 may be pin-coupled with the wall fixing bracket 135 at one end to enable rotation in the horizontal direction, with the other end coupled with the second vertical support member 120 swivel caster 125, as depicted in FIG. 5.

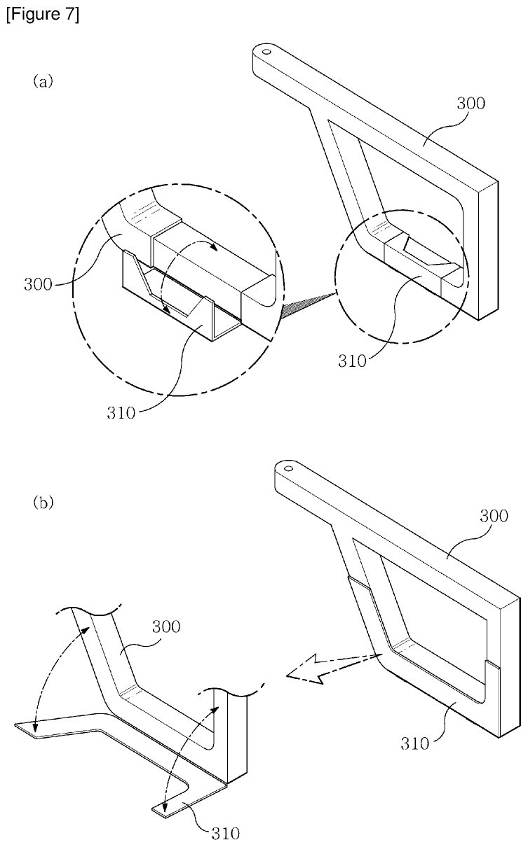

In FIG. 7(a) and FIG. 7(b), another specific embodiment of the mounting hook 310 for the mounting rack 300 is illustrated. Rather than being added to the mounting rack 300 as an external component, the mounting hook 310 is built into the lower part of the mounting rack 300 as a rotatable element that can be folded or spread out as needed.

That is, it does not protrude outside when the mounting rack 300 is folded inward to minimize its footprint while no bicycle parking is needed. The mounting hook 310 can be folded out and used as needed when the mounting rack 300 is folded outward for bicycles. A predetermined portion of the mounting rack 300 would be cut and removed to allow for the mounting hook 310 to be easily noticeable and accessible to users.

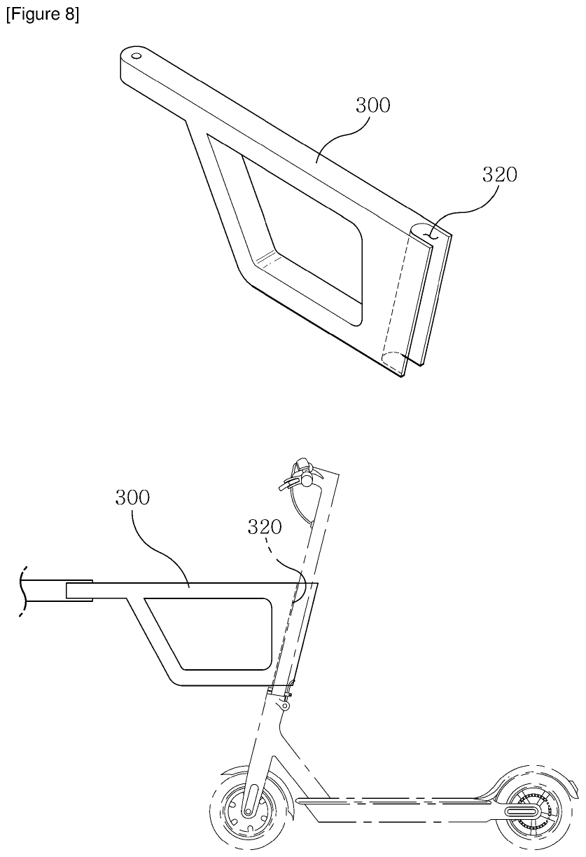

FIG. 8 illustrates another specific embodiment of the mounting rack 300, where the storage groove 320 stretches along the vertical direction on the side of the mounting rack 300 to accommodate the handle of an electric scooter (kickboard) for parking and storage.

To the accomplishment of the above and related object, this invention may be embodied in the form illustrated in the accompanying drawings, attention being called to the fact, however, that the drawings are illustrative only, and that changes may be made in the specific construction illustrated and described within the scope of the appended claims.

### LIST OF LABELS USED

100: Main bar
110: First vertical support member
115: Base bracket
120: Second vertical support member
125: Swivel caster
130: Horizontal support member
135: Wall fixing bracket
200: Sliding bracket
300: Mounting rack
310: Mounting hook
320: Storage groove

1. A swivel joint type bicycle stand, comprising: a main bar 100 installed in a horizontal direction; a sliding bracket 200 slidably coupled with the main bar 100 on one side; wherein a mounting rack 300 is rotatably coupled with the other side of said sliding bracket 200; and wherein said mounting rack 300 can be rotated and unfolded to be used for bicycle parking and storage and be rotated and folded when not in use; and wherein a plurality of said sliding bracket 200 can be slidably coupled with said main bar 100 on one end in a row with horizontal length increasing in sequence to enable said mounting rack 300 coupled with the other end to be rotated, folded, and arranged side by side while overlapping each other.

2. The swivel joint type bicycle stand of claim 1, comprising:
a mounting hook 310 which protrudes from the lower part of said mounting rack 300 for the mounting of front or back wheel of a bicycle.

3. The swivel joint type bicycle stand of claim 1 or claim 2, comprising:
a first vertical support member 110 which is connected to one end of said main bar 100 for support at a predetermined distance above ground or base surface; and a base bracket 115 anchored to the ground or base surface which is rotatably coupled with said first vertical support member 110.

4. The swivel joint type bicycle stand of claim 3, comprising:
a second vertical support member 120 which is connected to the other end of said main bar 100; and a swivel caster 125 which is rotatably coupled with the bottom of said second vertical support member 120 to enable sliding on the ground or base surface when said main bar 100 rotates.

5. The swivel joint type bicycle stand of claim 1 or claim 2, comprising:
a horizontal support member 130 which connects to one end of said main bar 100; and
a wall fixing bracket 135 fixed to the wall and coupled with the other end of aid horizontal support member 130 to keep said main bar 100 positioned at a predetermined distance from the wall and the ground or base surface of said main bar 100.

6. The swivel joint type bicycle stand of claim 5, wherein said horizontal support member 130 is rotatably coupled with pin connection to said wall fixing bracket 135.

7. The swivel joint type bicycle stand of claim 2, wherein the lower portion of said mounting hook 310 is rotatably coupled with and fold into or unfold out of said mounting rack 300.

8. The swivel joint type bicycle stand of claim 1 or claim 2, wherein said mounting rack 300 comprises a storage groove 320 which stretches along the vertical direction on the side of said mounting rack 300.
